(19) United States
(12) Patent Application Publication
(10) Pub. No.: US 2026/0209974 A1
(43) Pub. Date: Jul. 23, 2026

(54) WATER ELECTROLYSIS SYSTEM

(71) Applicant: HONDA MOTOR CO., LTD., TOKYO (JP)

(72) Inventor: Mizuho MURAKI, WAKO-SHI (JP)

(21) Appl. No.: 19/449,768

(22) Filed: Jan. 15, 2026

(30) Foreign Application Priority Data
Jan. 21, 2025 (JP) 2025-008389

(51) Int. Cl. C25B 15/023; C25B 9/65; C25B 9/77; C25B 15/08

(52) U.S. Cl. CPC C25B 15/023; C25B 9/65; C25B 9/77; C25B 15/08

(57) ABSTRACT

In a water electrolysis system, second current collectors of a plurality of water electrolysis cells each include a cut into which a gas generated in a second electrode catalyst layer flows and which communicates with a gas outlet path and canresonate a sound. The water electrolysis system includes a sound output device that outputs a sound to the gas outlet path, and a sound detection device that detects a resonant sound generated by resonation, in the cut, of the sound propagated from the sound output device to the cut via the gas outlet path. In the plurality of water electrolysis cells, the resonant frequencies of thesound in the cuts are different from each other.

### CROSS-REFERENCE TO RELATED APPLICATIONS

This application is based upon and claims the benefit of priority from Japanese Patent Application No. 2025-008389 filed on Jan. 21, 2025, the contents of which are incorporated herein by reference.

### BACKGROUND OF THE INVENTION

### Field of the Invention

The present disclosure relates to a water electrolysis system.

### Description of Related Art

In recent years, technological development has been conducted on water electrolysis systems that contribute to energy efficiency in order to ensure that more people have access to affordable, reliable, sustainable and modern energy.

JP 2020-172671 A discloses a water electrolysis system including a water electrolysis stack that generates hydrogen gas and oxygen gas by electrolyzing water. In this water electrolysis system, a hydrogen gas concentration meter is provided in a flow path for discharging the oxygen gas from the water electrolysis stack, and mixing of the hydrogen gas into the oxygen gas is detected.

### SUMMARY OF THE INVENTION

There has been a demand for a more satisfactory water electrolysis system.

The present disclosure has the object of solving the above-described problem.

An aspect of the present disclosure is characterized by a water electrolysis systemcomprising: a water electrolysis stack including a plurality of water electrolysis cells stacked on each other; a sound output device; anda sound detection device, wherein each of the plurality of water electrolysis cells includes: a membrane electrode assembly including an electrolyte membrane, a first electrode catalyst layer provided on one surface of the electrolyte membrane, and a second electrode catalyst layer provided on another surface of the electrolyte membrane; a first current collector disposed on one side of the membrane electrode assembly; a first flow path configured to supply water to the first electrode catalyst layer; a second current collector disposed on another side of the membrane electrode assembly; anda second flow path to which a gas generated in the second electrode catalyst layer is guided, the water electrolysis stack includes a gas outlet path configured to communicate with the second flow path of each of the plurality of water electrolysis cells and guide the gas generated in the second electrode catalyst layer, the second current collector of each of the plurality of water electrolysis cells includes a cut into which the gas generated in the second electrode catalyst layer flows, the cut being configured to communicate with the gas outlet path and resonate a sound, the sound output device is configured to output a sound to the gas outlet path, the sound detection device is configured to detect a resonant sound generated by resonation, in the cut, of the sound propagated from the sound output device to the cut via the gas outlet path, andin the plurality of water electrolysis cells, resonant frequencies of the sound in the cuts are different from each other.

According to the present disclosure, a more satisfactory water electrolysis system can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of a water electrolysis system;

FIG. 2 is a schematic cross-sectional view of a water electrolysis cell;

FIG. 3 is a cross-sectional view taken along line III-III of FIG. 2;

FIG. 4 is an explanatory cross-sectional view of thewater electrolysis cell;

FIG. 5 is a table showing a relationship between the length of a slit and the frequency of a resonant sound in a plurality of water electrolysis cells; and

FIG. 6 is a graph showing a relationship between the frequency and the sound pressure level of sounds detected by a sound detection device.

### DETAILED DESCRIPTION OF THE INVENTION

A water electrolysis system includes a water electrolysis stack in which a plurality of water electrolysis cells are stacked on each other. The water electrolysis cell includes a membrane electrode assembly, a first current collector, a first flow path, a second current collector, and a second flow path. The membrane electrode assembly is formed by providing a first electrode catalyst layer on one surface of an electrolyte membrane and providing a second electrode catalyst layer on the other surface of the electrolyte membrane. The first current collector is provided on one side of themembrane electrode assembly. The first flow path is configured to supply water (for example, pure water) to the first electrode catalyst layer. A first gas (for example, oxygen gas) generated in the first electrode catalyst layer by electrolysis of water is guided to the first flow path. The second current collector is provided on the other side of the membrane electrode assembly. A second gas (for example, hydrogen gas) generated in the second electrode catalyst layer by electrolysis of water is guided to the second flow path.

In an equal pressure water electrolysis stack in which the pressure in the first flow path and the pressure in the second flow path are equal, for example, the first gas generated in the first flow path may permeate through the electrolyte membrane and flow into the second flow path (cross-leakage may occur)due to deterioration of the electrolyte membrane or the like. When such a cross-leakage occurs, the concentration of the second gas in the second flow path decreases. The present disclosure can provide a water electrolysis system capable of detecting a change in the concentration of the second gas in a plurality of water electrolysis cells.

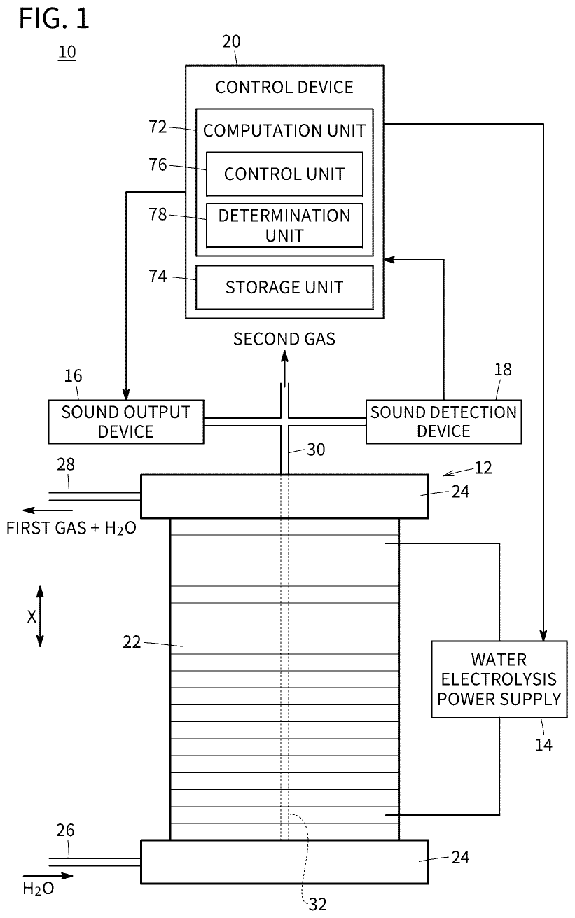

Hereinafter, a water electrolysis system 10 according to the present disclosure will be described. FIG. 1 is a schematic diagram of the water electrolysis system 10. As shown in FIG. 1, the water electrolysis system 10 includes an equal pressure water electrolysis stack 12, a water electrolysis power supply (a power supply for water electrolysis) 14, a sound output device 16, a sound detection device 18, and a control device 20.

The water electrolysis stack 12 includes a plurality of water electrolysis cells 22 and a pair of end plates 24. The water electrolysis cells 22 each generate a first gas and a second gas by electrolyzing water (for example, pure water). The first gas is one of oxygen gas or hydrogen gas. The second gas is the other of the oxygen gas and the hydrogen gas. The plurality of water electrolysis cells 22 are stacked on each other. The pair of end plates 24 sandwich the plurality of water electrolysis cells 22 in the stacking direction of the plurality of water electrolysis cells 22 (an X direction).

A water supply path 26, a water discharge path 28, and a gas discharge path 30 are connected to the water electrolysis stack 12. The water supply path 26 is configured to supply water to the water electrolysis stack 12. The water discharge path 28 is configured to discharge unreacted water that has not been used for water electrolysis and the first gas from the water electrolysis stack 12. The gas discharge path 30 is configured to discharge the second gas from the water electrolysis stack 12.

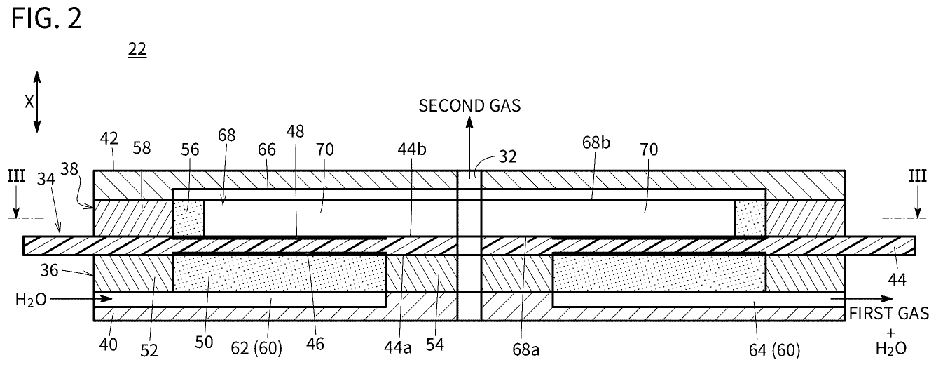

FIG. 2 is a schematic cross-sectional view of the water electrolysis cell 22. In FIG. 2, the X direction is the stacking direction of the plurality of water electrolysis cells 22. As shown in FIG. 2, the water electrolysis cell 22 is provided with a water inlet hole (not shown), a water outlet hole (not shown), and a gas outlet path 32. The water inlet hole is configured to guide the water supplied from the water supply path 26 (see FIG. 1) to the plurality of water electrolysis cells 22. The water outlet hole is configured to guide the first gas generated in each water electrolysis cell 22 and unreacted water to the water discharge path 28 (see FIG. 1). The gas outlet path 32 is configured to guide the second gas generated in each water electrolysis cell 22 to the gas discharge path 30 (see FIG. 1). The gas outlet path 32 extends in the stacking direction of the plurality of water electrolysis cells 22 (the X direction). The gas outlet path 32 is a hole (a gas outlet hole) penetrating the central portions of the plurality of water electrolysis cells 22 in the X direction.

The water electrolysis cells 22 each include a membrane electrode assembly 34, a first current collector 36, a second current collector 38, a first support member 40, and a second support member 42. Moreover, although other constituent elements may be provided in the water electrolysis cell 22 apart from these constituent elements, description of such elements will be omitted herein.

The membrane electrode assembly 34 includes an electrolyte membrane 44, a first electrode catalyst layer 46, and a second electrode catalyst layer 48. The membrane electrode assembly 34 is also referred to as a catalyst-coated membrane (CCM). The electrolyte membrane 44 is an ion exchange membrane capable of exchanging ions. The electrolyte membrane 44 is a proton exchange membrane (PEM). The electrolyte membrane 44 may be an anion exchange membrane (AEM).

The first electrode catalyst layer 46 is joined to one surface 44a of the electrolyte membrane 44. The second electrode catalyst layer 48 is joined to another surface 44b of the electrolyte membrane 44. Each of the first electrode catalyst layer 46 and the second electrode catalyst layer 48 is formed in an annular shape.

The first current collector 36 is disposed on one side of the membrane electrode assembly 34. The first current collector 36 is formed in an annular shape (for example, a circular ring shape). The first current collector 36 includes a first fluid passage portion 50 and a first outer peripheral portion 52. The first fluid passage portion 50 is disposed so as to face the first electrode catalyst layer 46. The first fluid passage portion 50 is formed to allow water and the first gas to pass therethrough in the X direction. The first fluid passage portion 50 is formed of, for example, a porous member. The first outer peripheral portion 52 is not permeable to water and the first gas.

An inner peripheral member 54 is disposed on the inner side (radially inward) of the first current collector 36. The inner peripheral member 54 is not permeable to water and the first gas. That is, the inner peripheral member 54 prevents the water and the first gas passing through the first fluid passage portion 50 from being guided to the gas outlet path 32.

The second current collector 38 is disposed on the other side of the membrane electrode assembly 34. The second current collector 38 is formed in an annular shape (for example, a circular ring shape). The gas outlet path 32 is located inthe central portion of the second current collector 38. This enables the water electrolysis stack 12 to be configured compactly. The second current collector 38 includes a second fluid passage portion 56 and a second outer peripheral portion 58. The second fluid passage portion 56 is disposed so as to face the second electrode catalyst layer 48. The second fluid passage portion 56 is formed to allow the second gas to pass therethrough in the X direction. The second fluid passage portion 56 is formed of, for example, a porous member. The second outer peripheral portion 58 is not permeable to the second gas. A cut 68 is formed in the second current collector 38. The details of the cut 68 will be described later.

The first support member 40 supports the first current collector 36 and the inner peripheral member 54. The first current collector 36 is disposed between the membrane electrode assembly 34 and the first support member 40. A first flow path 60 is formed in the first support member 40. The first flow path 60 is configured to supply water to the first electrode catalyst layer 46. The first flow path 60 does not communicate with the gas outlet path 32. The first flow path 60 includes a water inflow path 62 and a water outflow path 64. The water inflow path 62 serves to guide water guided from the water inlet hole (not shown) to the first electrode catalyst layer 46. The water outflow path 64 serves to guide the first gas generated in the first electrode catalyst layer 46 and unreacted water to the water outlet hole (not shown).

The second support member 42 supports the second current collector 38. The second current collector 38 is disposed between the membrane electrode assembly 34 and the second support member 42. A second flow path 66 is formed in the second support member 42. The second gas generated in the second electrode catalyst layer 48 is guided to the second flow path 66. The second flow path 66 communicates with the gas outlet path 32. The second gas in the second flow path 66 is guided to the gas outlet path 32. Note that the second flow path 66 does not communicate with the water inlet hole and the water outlet hole.

As shown in FIG. 1, the water electrolysis power supply 14 is a DC power supply. The water electrolysis power supply 14 supplies an electric current to the first current collector 36 and the second current collector 38. A voltage is applied between the first current collector 36 and the second current collector 38 by the water electrolysis power supply 14.

The sound output device 16 serves to output a sound to the gas outlet path 32 of the water electrolysis stack 12. The sound output device 16 is provided in the gas discharge path 30. The sound output from the sound output device 16 propagates to the gas outlet path 32 of the water electrolysis stack 12 via the gas discharge path 30. The sound output device 16 is, for example, a speaker. The sound output device 16 outputs white noise.

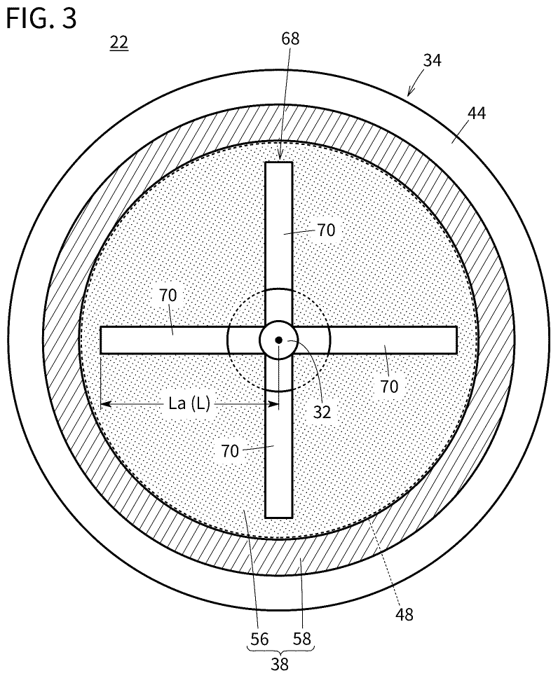

FIG. 3 is a cross-sectional view taken along line III-III of FIG. 2. As shown in FIGS. 2 and 3, in each of the plurality of water electrolysis cells 22, the cut 68 is formed in the second current collector 38. The sound (white noise) output from the sound output device 16 to the gas outlet path 32 propagates into the cut 68. The second gas generated in the second electrode catalyst layer 48 flows into the cut 68, and the cut 68 communicates with the gas outlet path 32 and canresonate the sound. The cut 68 is formed to allow the first gas that has cross-leaked through the electrolyte membrane 44 to flow therein.

As shown in FIG. 2, the cut 68 includes an opening 68a that opens in a surface of the second current collector 38 that faces the membrane electrode assembly 34, and an opening 68b that opens in a surface of the second current collector 38 that faces the opposite side to the membrane electrode assembly 34. The opening 68a faces the second electrode catalyst layer 48. As a result, the second gas generated in the second electrode catalyst layer 48 can be made to directly flow into the cut 68. Further, the first gas that has cross-leaked through the electrolyte membrane 44 can be made to flow into the cut 68 from the opening 68a.

The cut 68 communicates with the second flow path 66 via the opening 68b. As a result, the second gas inside the second flow path 66 can be made to flow into the cut 68. That is, the cut 68 penetrates the second current collector 38 in the thickness direction thereof (the X direction). Accordingly, the second gas can be made to efficiently flow into the cut 68. In addition, a sound having an appropriate sound pressure can be propagated into the cut 68.

The cut 68 may not penetrate the second current collector 38 in the thickness direction. The cut 68 may be a recess including only one of the opening 68a or the opening 68b.

As shown in FIGS. 2 and 3, the cut 68 includes a plurality of slits 70. By providing the plurality of slits 70, the first gas that has cross-leaked through the electrolyte membrane 44 can be made to easily flow into the cut 68. In the present embodiment, the cut 68 includes four slits 70 (see FIG. 3). The slits 70 extend in the surface direction of the second current collector 38 from the gas outlet path 32. In other words, the slits 70 extend outward in the radial direction of the second current collector 38. The slits 70 extend linearly. The slits 70 may be bent when viewed from the X direction.

The plurality of slits 70are arranged at equal intervals in the circumferential direction of the second current collector 38. In other words, the four slits 70 are arranged at intervals of 90 degrees in the circumferential direction of the second current collector 38. The width of each slit 70 can be set as appropriate. The plurality of slits 70 have the same size and shape.

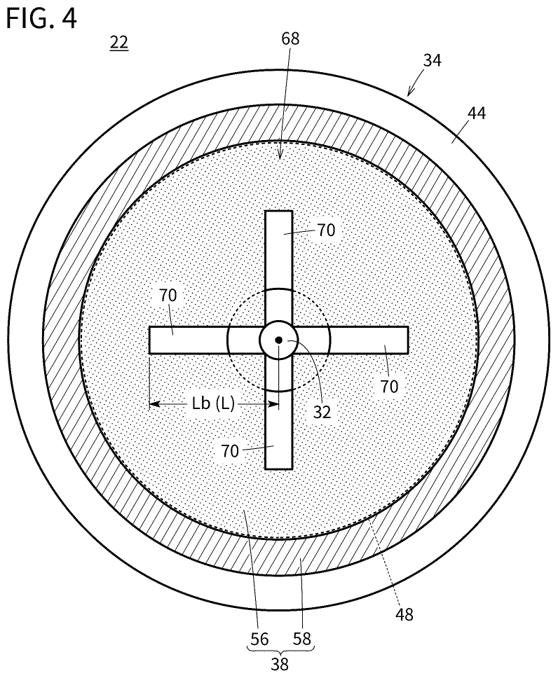

FIG. 4 is an explanatory cross-sectional view of the water electrolysis cell 22. The position where the water electrolysis cell 22 shown in FIG. 4 is stacked is different from the position where the water electrolysis cell 22 shown in FIG. 3 is stacked. As shown in FIGS. 3 and 4, in the plurality of water electrolysis cells 22, lengths L of the slits 70 from the gas outlet path 32 are different from each other. It should be noted that the length L of the slit 70 from the gas outlet path 32 means a length from the center of the gas outlet path 32 to an end of the slit 70 in the extending direction thereof.

Specifically, a length La of the slit 70 shown in FIG. 3 is greater than a length Lb of the slit 70 shown in FIG. 4. In the present embodiment, the lengths L of the slits 70 are different from each other in all the water electrolysis cells 22 included in the water electrolysis stack 12. The resonant frequency of the sound in the cut 68 is determined by the length L of the slit 70 from the gas outlet path 32. Therefore, in the plurality of water electrolysis cells 22, the resonant frequencies of the sound in the cuts 68 are different from each other.

That is, in the present embodiment, since the cut 68 includes the slits 70, the resonant frequency of the sound in the cut 68 can be changed according tothe length L of each slit 70 from the gas outlet path 32. Accordingly, the resonant frequencies of the sound in the cuts 68 can be made different from each other in the plurality of water electrolysis cells 22 with a simple configuration.

The plurality of (four in the present embodiment) slits 70 formed in one second current collector 38 have the same shape and size. That is, the lengths L of the plurality of slits 70 formed in one second current collector 38 are equal to each other. Note that the shape and size (the length L) of the plurality of slits 70 formed in one second current collector 38 may have variations of the order of processing errors. The cut 68 may include one, two, three, or five or more slits 70.

As shown in FIG. 1, the sound detection device 18 detects a resonant sound generated by resonation, in each cut 68, of the sound propagated from the sound output device 16 to the cut 68 via the gas outlet path 32. The sound detection device 18 is provided in the gas discharge path 30. The sound detection device 18 is, for example, a microphone.

Detection signals output from the sound detection device 18 are input to the control device 20. The control device 20 includes a computation unit 72 and a storage unit 74. Although other constituent elements may be provided in the control device 20 apart from these constituent elements, description of such elements will be omitted herein. A program for executing a detection method (an inspection method) for the water electrolysis system 10 according to the present embodiment can be installed in the storage unit 74.

The computation unit 72 is constituted by a processor such as a central processing unit (CPU) or a graphics processing unit (GPU). That is, the computation unit 72 is constituted by processing circuitry.

The computation unit 72 includes a control unit 76 and a determination unit 78. The control unit 76 and the determination unit 78 can be realized by the computation unit 72 executing a program stored in the storage unit 74.

At least part of the control unit 76 and the determination unit 78 may be realized by an integrated circuit such as an application specific integrated circuit (ASIC) or a field-programmable gate array (FPGA). Further, at least part of the control unit 76 and the determination unit 78 may be constituted by an electronic circuit including a discrete device.

The control unit 76 controls the water electrolysis power supply 14 and the sound detection device 18. The determination unit 78 determines whether or not the concentration of the second gas in the plurality of water electrolysis cells 22 has decreased (whether or not a cross-leakage of the first gas has occurred), based on the detection signals output from the sound detection device 18.

Next, a basic operation of the water electrolysis stack 12 will be described. In the present embodiment, the water electrolysis stack 12 is electrically connected to the water electrolysis power supply 14 such that each first current collector 36 serves as an anode and each second current collector 38 serves as a cathode.

Water is supplied from the water supply path 26 to the water electrolysis stack 12 by a water pump (not shown), and an electric current is passed through the first current collector 36 and the second current collector 38 by the water electrolysis power supply 14. The water supplied from the water supply path 26 is guided to the first electrode catalyst layer 46 via the first flow path 60 (the water inflow path 62). In this case, oxygen gas is generated as the first gas in the first electrode catalyst layer 46, and hydrogen gas is generated as the second gas in the second electrode catalyst layer 48. The oxygen gas generated in the first electrode catalyst layer 46 is discharged to the water discharge path 28 together with unreacted water via the first flow path 60 (the water outflow path 64). The hydrogen gas generated in the second electrode catalyst layer 48 is guided to the gas outlet path 32 via the second flow path 66. The hydrogen gas in the gas outlet path 32 is discharged to the gas discharge path 30. During the driving of the water electrolysis stack 12, the pressure in the first flow path 60 and the pressure in the second flow path 66 are equal to each other. However, due to pressure fluctuation, a pressure difference of about several hundred kPa may occur between the pressures (several tens of MPa) of the two electrodes.

In the water electrolysis system 10, the water electrolysis stack 12 may be electrically connected to the water electrolysis power supply 14 such that the first current collector 36 serves as a cathode and the second current collector 38 serves as an anode. In this case, hydrogen gas is generated as the first gas in the first electrode catalyst layer 46, and oxygen gas is generated as the second gas in the second electrode catalyst layer 48.

In the present embodiment, the control unit 76 controls the sound output device 16 to output white noise from the sound output device 16 to the gas outlet path 32 via the gas discharge path 30. The white noise output to the gas outlet path 32 is propagated into the cuts 68 of the second current collectors 38 of the plurality of water electrolysis cells 22.

In each cut 68, a sound of the white noise that has the same frequency as the resonant frequency of the cut 68 resonates, to thereby generate a resonant sound. The resonant frequency is determined by the length of the slit 70. Therefore, the frequencies of the resonant sounds generated from the plurality of water electrolysis cells 22 are different from each other. In the present embodiment, since the sound output device 16 outputs white noise, resonant sounds having different resonant frequencies can be efficiently generated in the plurality of water electrolysis cells 22.

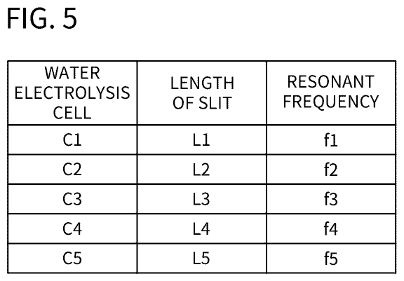

FIG. 5 is a table showing a relationship between the length of the slit 70 and the frequency of the resonant sound in the plurality of water electrolysis cells 22. FIG. 5 illustrates the relationship between the length L of the slit 70 and the resonant frequency infive water electrolysis cells 22. As shown in FIG. 5, in the case where the length of the slit 70 is set to L1 to L5 in the plurality of water electrolysis cells C1 to C5, the resonant frequency is f1 to f5.

The resonant sounds generated in the cuts 68 of the plurality of water electrolysis cells 22 propagate to the gas discharge path 30 via the gas outlet path 32. The resonant sounds propagated to the gas discharge path 30 are detected by the sound detection device 18.

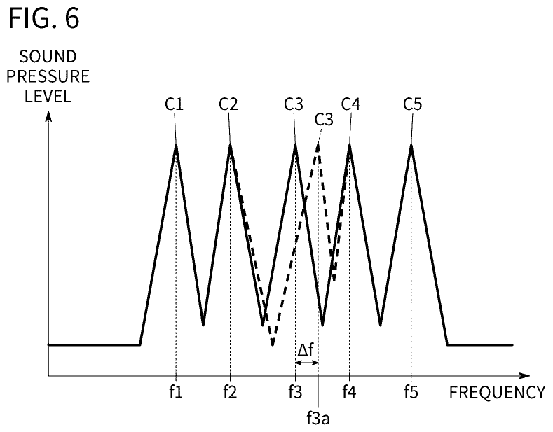

FIG. 6 is a graph showing a relationship between the frequency and the sound pressure level of sounds detected by the sound detection device 18. FIG. 6 shows an example in which the resonant sounds generated in the five water electrolysis cells 22 shown in FIG. 5 are detected by the sound detection device 18. As indicated by the waveform of the solid line in FIG. 6, in the case where the cross-leakage of the first gas does not occur in the five water electrolysis cells 22, the peak value of the sound pressure level is detected at each of the plurality of resonant frequencies f1 to f5.

For example, in the water electrolysis cell C3, in the case where the first gas has cross-leaked due to deterioration of the electrolyte membrane 44 or the like, the first gas is mixed into the cut 68 of the water electrolysis cell C3. Then, the concentration of the second gas in the cut 68 decreases, and thus the sound speed in the cut 68 changes. When the sound speed in the cut 68 changes, the resonant frequency of the sound in the cut 68 of the water electrolysis cell C3 is shifted from f3 to f3a. Therefore, as indicated by the waveform of the broken line in FIG. 6, the peak value of the sound pressure level of the resonant sound generated in the cut 68 of the water electrolysis cell C3 is detected at the resonant frequency f3a. The determination unit 78 determines that the concentration of the second gas has decreased (cross-leakage has occurred) in the water electrolysis cell C3 in the case where a difference Δf (an amount of shift) between the resonant frequency f3a and the resonant frequency f3 is greater than a determination value that is determined in advance.

According to the present embodiment, in the case where the gas (the first gas) generated in the first electrode catalyst layer 46 cross-leaks due to deterioration of the electrolyte membrane 44 or the like, the first gas can be made to flow into the cut 68 to which the gas (the second gas) generated in the second electrode catalyst layer 48 is guided. When the first gas flows into the cut 68 and the concentration of the second gas changes, the sound speed in the cut 68 changes. Then, the resonant frequency of the sound in the cut 68 is shifted from the resonant frequency obtained in the case where the first gas is not mixed in the cut 68, and therefore, the change in the concentration of the second gas can be detected by the sound detection device 18. Further, since the resonant frequencies of the sound in the cuts 68 are different from each other, it is possible to detect a water electrolysis cell 22 in which the concentration of the second gas has changed among the plurality of water electrolysis cells 22. Therefore, a more satisfactory water electrolysis system 10 can be provided.

The following supplementary notes are further disclosed in relation to the above-described embodiment.

### Supplementary Note 1

The water electrolysis system (10) of the present disclosure includes the water electrolysis stack (12) including the plurality of water electrolysis cells (22) stacked on each other, wherein each of the plurality of water electrolysis cells includes: the membrane electrode assembly (34) including the electrolyte membrane (44), the first electrode catalyst layer (46) provided on one surface (44a) of the electrolyte membrane, and the second electrode catalyst layer (48) provided on the other surface (44b) of the electrolyte membrane; the first current collector (36) disposed on one side of the membrane electrode assembly; the first flow path (60) configured to supply water to the first electrode catalyst layer; the second current collector (38) disposed on the other side of the membrane electrode assembly; and the second flow path (66) to which a gas generated in the second electrode catalyst layer is guided, wherein the water electrolysis stack includes the gas outlet path (32) configured to communicate with the second flow path of each of the plurality of water electrolysis cells and guide the gas generated in the second electrode catalyst layer, the second current collector of each of the water electrolysis cells includes the cut (68) into which the gas generated in the second electrode catalyst layer flows, the cut being configured to communicate with the gas outlet path and resonate a sound, wherein the water electrolysis system further includes the sound output device (16) configured to output a sound to the gas outlet path; and the sound detection device (18) configured to detect a resonant sound generated by resonation, in the cut, of the sound propagated from the sound output device to the cut via the gas outlet path, and wherein, in the plurality of water electrolysis cells, the resonant frequencies of thesound in the cuts are different from each other.

According to such a configuration, in the case where the gas (the first gas) generated in the first electrode catalyst layer cross-leaks due to deterioration of the electrolyte membrane or the like, the first gas can be made to flow into the cut to which the gas (the second gas) generated in the second electrode catalyst layer is guided. When the first gas flows into the cut and the concentration of the second gas changes, the sound speed in the cut changes. Then, the resonant frequency of the sound in the cut is shifted from the resonant frequency obtained in the case where the first gas is not mixed in the cut, and therefore, the change in the concentration of the second gas can be detected by the sound detection device. Further, since the resonant frequencies of the sound in the cuts are different from each other, it is possible to detect a water electrolysis cell in which the concentration of the second gas has changed among the plurality of water electrolysis cells. Therefore, a more satisfactory water electrolysis system can be provided.

### Supplementary Note 2

In the water electrolysis system according to Supplementary Note 1, the gas outlet path may extend in the stacking direction of the plurality of water electrolysis cells so as to penetrate the water electrolysis cells, the cut may include the slit (70) extending in the surface direction of the second current collector from the gas outlet path, and in the plurality of water electrolysis cells, lengths of the slits from the gas outlet path may be different from each other.

According to such a configuration, since the cut includes the slit, the resonant frequency of the sound in the cut can be changed according tothe length of the slit from the gas outlet path. Therefore, the resonant frequencies of the sound in the cuts can be made different from each other in the plurality of water electrolysis cells with a simple configuration.

### Supplementary Note 3

In the water electrolysis system according to Supplementary Note 1 or 2, the gas outlet path may be located in a central portion of the second current collector.

According to such a configuration, the water electrolysis stack can be configured compactly.

### Supplementary Note 4

In the water electrolysis system according to Supplementary Note 2, the cut may include a plurality of the slits.

According to such a configuration, the cross-leaked first gas can be made to easily flow into the cut.

### Supplementary Note 5

In the water electrolysis system according to any one of Supplementary Notes 1 to 4, the cut may include the opening (68a) configured toopen in a surface of the second current collector that faces the membrane electrode assembly, and the opening may face the second electrode catalyst layer.

According to such a configuration, the second gas generated in the second electrode catalyst layer can be made to directly flow into the cut.

### Supplementary Note 6

In the water electrolysis system according to any one of Supplementary Notes 1 to 5, the cut may communicate with the second flow path.

According to such a configuration, the second gas in the second flow path can be made to flow into the cut.

### Supplementary Note 7

In the water electrolysis system according to Supplementary Note 5 or 6, the cut may penetrate the second current collector in the thickness direction thereof.

According to such a configuration, the second gas can be made to efficiently flow into the cut. In addition, a sound having an appropriate sound pressure can be propagated into the cut.

### Supplementary Note 8

In the water electrolysis system according to any one of Supplementary Notes 1 to 7, the sound output device may output white noise to the gas outlet path.

According to such a configuration, resonant sounds having different resonant frequencies can be efficiently generated in the plurality of water electrolysis cells.

Although the present disclosure has been described in detail, the present disclosure is not limited to the above-described individual embodiments. Various additions, replacements, modifications, partial deletions, and the like can be made to these embodiments without departing from the essence and gist of the present disclosure or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A water electrolysis system comprising:
a water electrolysis stack including a plurality of water electrolysis cells stacked on each other;
a sound output device; and
a sound detection device,
wherein each of the plurality of water electrolysis cells includes:
a membrane electrode assembly including an electrolyte membrane, a first electrode catalyst layer provided on one surface of the electrolyte membrane, and a second electrode catalyst layer provided on another surface of the electrolyte membrane;
a first current collector disposed on one side of the membrane electrode assembly;
a first flow path configured to supply water to the first electrode catalyst layer;
a second current collector disposed on another side of the membrane electrode assembly; and
a second flow path to which a gas generated in the second electrode catalyst layer is guided,
the water electrolysis stack includes a gas outlet path configured to communicate with the second flow path of each of the plurality of water electrolysis cells and guide the gas generated in the second electrode catalyst layer,
the second current collector of each of the plurality of water electrolysis cells includes a cut into which the gas generated in the second electrode catalyst layer flows, the cut being configured to communicate with the gas outlet path and resonate a sound,
the sound output device is configured to output a sound to the gas outlet path,
the sound detection device is configured to detect a resonant sound generated by resonation, in the cut, of the sound propagated from the sound output device to the cut via the gas outlet path, and
in the plurality of water electrolysis cells, resonant frequencies of thesound in the cuts are different from each other.

2. The water electrolysis system according to claim 1, wherein
the gas outlet path extends in a stacking direction of the plurality of water electrolysis cells so as to penetrate the water electrolysis cells,
the cut includes a slit extending in a surface direction of the second current collector from the gas outlet path, and
in the plurality of water electrolysis cells, lengths of the slits from the gas outlet path are different from each other.

3. The water electrolysis system according to claim 2, wherein
the gas outlet path is located in a central portion of the second current collector.

4. The water electrolysis system according to claim 2, wherein
the cut includes a plurality of the slits.

5. The water electrolysis system according to claim 1, wherein
the cut includes an opening configured toopen in a surface of the second current collector that faces the membrane electrode assembly, and
the opening faces the second electrode catalyst layer.

6. The water electrolysis system according to claim 1, wherein
the cut communicates with the second flow path.

7. The water electrolysis system according to claim 5, wherein
the cut penetrates the second current collector in a thickness direction of the second current collector.

8. The water electrolysis system according to claim 1, wherein
the sound output device outputs white noise to the gas outlet path.
